(19) United States
(12) Patent Application Publication
(10) Pub. No.: US 2015/0274400 A1
(43) Pub. Date: Oct. 1, 2015

(54) MICROWAVABLE FOOD PACKAGING, AND RELATED PRODUCTS AND METHODS

(71) Applicant: GENERAL MILLS, INC., Minneapolis, MN (US)

(72) Inventors: Matthew W. Lorence, Plymouth, MN (US); Taryn Mason, St. Paul, MN (US); Diane R. Rosenwald, Plymouth, MN (US)

(73) Assignee: GENERAL MILLS, INC., Minneapolis, MN (US)

(21) Appl. No.: 14/435,168

(22) PCT Filed: Oct. 11, 2013
(86) PCT No.: PCT/US13/64567

§ 371 Date: Apr. 12, 2015

Related U.S. Application Data
(60) Provisional application No. 61/713,066, filed on Oct. 12, 2012.

(51) Int. Cl. B65D 81/34; A23L 1/025

(52) U.S. Cl. CPC B65D 81/3453; A23L 1/0255; A23V 2002/00

(57) ABSTRACT

A microwavable food package may comprise a container comprising at least one sidewall, a first closed end and a second open end opposite the first closed end, the at least one sidewall and the first closed end together defining an interior volume configured to hold foodstuff. The microwavable food package may further comprise a cover configured to cover the open end. The at least one sidewall may comprise a composite including a microwave regulating material to regulate incident microwave radiation being transmitted through the at least one sidewall into the interior volume. The cover or the closed end of the container may comprise a microwave regulating material to regulate incident microwave radiation being transmitted through an end of the container into the interior volume.

### TECHNICAL FIELD

The present disclosure relates to food packaging, and related products and methods, for controlling the heating of foods in a microwave oven. In particular, the present disclosure relates to food packaging, and related products and methods, that provide differential heating of foodstuffs positioned in the packaging, for example, as a multi-component food product.

### BACKGROUND

The section headings used herein are for organizational purposes only and are not to be construed as limiting the subject matter described in any way.

To enhance the appeal and marketability of a food product beyond the food material itself, food manufacturers often attempt to present traditional food products in more convenient packaging arrangements. As an example, microwavable foods, such as, for example, frozen microwavable foods offer the convenience of having the food prepared in advance, while preparing the food for serving only takes a few minutes, or less, by exposing the food to microwave energy. Various food products, however, combine both hot and cold elements, such as, for example, desserts, in which it is desirable to serve one portion of the dessert hot, while serving another portion of the dessert cold. Such food products, therefore, require specialized packaging and/or product arrangements within the packaging, which provide differential heating between the food portions when microwaved to heat one portion, while protecting another portion to keep it frozen and/or chilled.

With various additional food products, it may be desirable to serve the food product at a relatively uniform temperature, such as, for example, a food product that is desired to be evenly thawed, heated, and/or baked.

Temperature differentials, differential heating, and moderated heating have traditionally been achieved through the use of package regulating materials, such as, for example, various metal materials that are used in conjunction with the food package to shield and/or modify incident radiation being transmitted through the package to certain portions of the food product within the package. For example, it has long been practiced in microwave cooking to use microwave reflective packaging with various sized apertures to control the amount of microwave radiation simultaneously impinging on various foods within the package. Such packaging requires that the foods desired to be heated are separated in the package with each food having one or more preselected apertures in the shield adjacent the food. Thus, although such packaging may be relatively effective for certain food concepts (which allow for the separation of product components), this type of packaging is expensive and still relatively inconvenient for consumers who must combine the food components after microwaving.

Microwave regulating materials, such as, for example, microwave shielding materials have also been applied to traditional product packaging, such as, for example, microwavable cups and trays, in the form of adhesive foil labels, applied to the outside of the cup or tray wall. Although such packaging may be relatively effective for a greater variety of food products, this type of packaging is difficult to scale up for mass production due to various complications with the secondary application of the shield layer to the product package.

In the same manner, microwave regulating materials have also been applied to packaging covers, such as, for example, traditional cup lids, to further prevent and/or modify incident radiation being transmitted through the top of the package. In various circumstances, however, such lids may interact with adjoining portions of the cup wall causing scorching and burning of the cup, which is both unattractive and unappealing for consumers preparing the food product.

Thus, it may be desirable to provide microwavable food packaging, and related methods, that effectively provide differential heating between two or more foodstuffs held within the packaging and/or that provide uniform heating of, for example, one or more foodstuffs held within the packaging, which are convenient for consumers, and may be easily scaled up for mass production. It may be further desirable to provide microwavable food packaging options that provide effective regulation of microwave energy at a top portion of the packing, while preventing scorching and burning of the packaging when the product is microwaved.

### SUMMARY

Various exemplary embodiments of the present disclosure may solve one or more of the above-mentioned problems and/or may demonstrate one or more of the above-mentioned desirable features. Other features and/or advantages may become apparent from the description that follows.

In accordance with various exemplary embodiments, a microwavable food package may comprise a container comprising at least one sidewall, a first closed end and a second open end opposite the first closed end, the at least one sidewall and the first closed end together defining an interior volume configured to hold foodstuff. The microwavable food package may further comprise a cover configured to cover the open end. The at least one sidewall may comprise a composite including a microwave regulating material to regulate incident microwave radiation being transmitted through the at least one sidewall into the interior volume. The cover or the closed end of the container may comprise a microwave regulating material to regulate incident microwave radiation being transmitted through an end of the container into the interior volume.

In accordance with various additional exemplary embodiments, a microwavable product may comprise a cup comprising a sidewall, a closed end, and an open end opposite the closed end, wherein the sidewall and the closed end together define an interior volume, and wherein the cup further comprises a lip surrounding the open end. The microwavable product may further comprise a first layer of foodstuff disposed within the interior volume, the first layer of foodstuff having a thickness and dielectric properties. The microwavable product may additionally comprise a second layer of foodstuff disposed within the interior volume below the first layer and closer to the closed end than the first layer, the second layer of foodstuff having a thickness and dielectric properties, wherein the foodstuffs of the first and second layers differ from each other. The microwavable food product may further comprise a cover configured to be removably secured to the cup at the open end. The cover may comprise a microwave regulating material disposed to regulate incident microwave radiation from being transmitted through the open end into the interior volume in a secured position of the cover to the cup. The sidewall of the cup may comprise a composite including a microwave regulating material disposed to surround at least the first layer of foodstuff to regulate incident microwave radiation being transmitted through the sidewall into the interior volume at a location of the first layer.

In accordance with various further exemplary embodiments, a method for preparing a food product may comprise applying microwave energy to a container holding at least a first foodstuff and a second foodstuff, the first and second foodstuffs being held in axially layered relation to each other within an interior volume of the container. The method may further comprise regulating the microwave energy being transmitted through a first end of the container to the first foodstuff. The method may additionally comprise regulating the microwave energy being transmitted through a sidewall of the container to the first foodstuff via a composite including a microwave regulating material. The method may further comprise heating the second foodstuff with the microwave energy transmitted through the sidewall and a second end of the container.

Additional objects and advantages will be set forth in part in the description which follows, and in part will be obvious from the description, or may be learned by practice of the present disclosure. At least some of those objects and advantages may be realized and attained by means of the elements and combinations particularly pointed out in the appended claims and their equivalents.

It is to be understood that both the foregoing general description and the following detailed description are exemplary and explanatory only and are not restrictive of the present disclosure or claims.

### BRIEF DESCRIPTION OF THE DRAWINGS

The present disclosure and claims can be better understood from the following detailed description either alone or together with the accompanying drawings. The drawings are included to provide a further understanding, and are incorporated in and constitute a part of this specification. The drawings illustrate one or more exemplary embodiments of the present disclosure and together with the description serve to explain various principles and operation.

FIG. 1 is a perspective view, with portions broken away to show internal components, of an exemplary embodiment of a microwavable food package with a container, cover, and lid in accordance with the present disclosure;

FIG. 2 is a perspective view of an exemplary embodiment of the container of the food package of FIG. 1;

FIG. 3 is a perspective view of an exemplary embodiment of the container and cover of the food package of FIG. 1;

FIG. 4 is a side view of the food package of FIG. 1;

FIG. 5 is a cross-sectional view of the food package of FIG. 1 taken through line 5-5 of FIG. 4, which shows an exemplary embodiment of a microwavable food arrangement in accordance with the present disclosure within the food package of FIG. 1;

FIG. 6 shows a partial detailed view of the container, cover, and lid of FIG. 5;

FIG. 7 is a cross-sectional view of the food package of FIG. 1 taken through line 5-5 of FIG. 4, which shows another exemplary embodiment of a microwavable food arrangement in accordance with the present disclosure within the food package of FIG. 1;

FIG. 8 shows a plan view of an exemplary embodiment of a blank used to form the container of the food package of FIG. 1;

FIG. 9A shows a top perspective view of an exemplary embodiment of the lid of the food package of FIG. 1;

FIG. 9B shows a bottom perspective view of the lid of FIG. 9A;

FIG. 10A shows a top perspective view of another exemplary embodiment of a lid in accordance with the present disclosure;

FIG. 10B shows a bottom perspective view of the lid of FIG. 10A;

FIG. 11A shows a top perspective view of yet another exemplary embodiment of a lid in accordance with the present disclosure;

FIG. 11B shows a bottom perspective view of the lid of FIG. 11A;

FIG. 12 shows a side view of another exemplary embodiment of a microwavable food package with a container and cover in accordance with the present disclosure; and

FIG. 13 is a cross-sectional view of the food package of FIG. 12 taken through line 13-13 of FIG. 12, which shows another exemplary embodiment of a microwavable food arrangement in accordance with the present disclosure within the food package of FIG. 12.

### DETAILED DESCRIPTION OF VARIOUS EXEMPLARY EMBODIMENTS

Reference will now be made in detail to various exemplary embodiments of the present disclosure, examples of which are illustrated in the accompanying drawings.

To enhance their appeal and marketability, traditional food products have been prepared in advance and packaged in microwavable packaging, which allows a consumer to prepare the food product for consumption within a relatively short period of time by exposing the food product to microwave radiation. With various food products, however, it is desirable to serve portions of the food product at different temperatures, such as, for example, one portion of the food hot, while serving another portion of the food cold. Such food products, therefore, would benefit from packaging and/or product arrangements within the packaging that provide differential heating between the food portions when microwaved to heat, for example, the first portion, while keeping the remaining portion frozen and/or chilled. With various additional food products, it is desirable to serve the food product at a relatively uniform temperature, such as, for example, a food product that is desired to be evenly thawed, heated, and/or baked. Such food products, therefore, also would benefit from packaging that controls how the product is heated when the package is exposed to microwave radiation.

Although microwave packaging that allows for differential heating and/or uniform heating is known in the art, there is a continued need to improve upon such packaging, and the foodstuff and/or foodstuff arrangements held within such packaging, to both increase the overall quality of the microwavable food products and the ease at which such products are produced.

To provide improved microwavable food packaging, various exemplary embodiments of the present disclosure provide microwavable food packages, products, and methods for preparing a food product that utilize microwave regulating materials and placement thereof to control the amount of incident microwave radiation being transmitted through various portions of the package to an interior volume thereof. Various exemplary embodiments of the present disclosure, for example, provide microwavable food packages that utilize a container, a sidewall of which comprises a composite including a microwave regulating material to control the amount of incident microwave radiation being transmitted through the sidewall of the container into the interior volume. In various exemplary embodiments, a closed end of the container may also comprise a microwave regulating material to control the amount of incident microwave radiation being transmitted through the closed end of the container into the interior volume. In various additional embodiments, a cover configured to cover an open end of the container may comprise a microwave regulating material to control the amount of incident microwave radiation being transmitted through the open end of the container into the interior volume. Thus, various exemplary embodiments of the present disclosure contemplate microwavable food packages that may provide differential heating between two or more foodstuffs held within the container, and/or that may provide uniform heating of one or more foodstuffs held within the container, by effectively regulating the amount of incident microwave radiation being transmitted to at least a first layer of foodstuff positioned radially adjacent to the composite, while also eliminating the secondary production step of applying a microwave regulating layer to the container.

Microwave shields and variations thereof refer to barriers which generally preclude the transmission or receipt of microwave energy into an area protected by the shield. In other words, when a microwave hits a microwave shield almost all of the power is reflected from the surface of the shield, thereby preventing the microwave from being transmitted into and through the shield. Microwave moderators and variations thereof refer to barriers which partially attenuate and/or modify microwave energy as it passes into an area protected by the moderator. In other words, when a microwave hits a microwave moderator only a portion of the power is transmitted through the moderator, and/or absorbed by the moderator and converted to heat. As used herein, the term “microwave regulating material” and variations thereof refer to a material that substantially controls the amount of incident microwave radiation being transmitted into and through the material, and includes, for example, microwave shielding materials, microwave moderating materials, and various combinations thereof.

Various exemplary embodiments of the present disclosure contemplate, for example, microwave regulating materials comprising electrically conductive materials, such as, for example, metallic materials, including, but not limited to, metallic foils or patterned foils (e.g., created by demetallization of a foil on or in a polymer carrier) made of aluminum, copper, tin, brass, steel, or various metal or metal alloys which are effective to reflect microwaves. Those of ordinary skill in the art would understand, however, that the above materials are exemplary only and that microwave regulating materials in accordance with the present disclosure may comprise various electrically conductive materials. Furthermore, those of ordinary skill in the art would understand that microwave regulating materials in accordance with the present disclosure include materials that reflect all (i.e., provide 100% reflectance) of the microwaves which they are exposed to, and materials that reflect only a portion (i.e., provide 99.9% to 0% reflectance) of the microwaves which they are exposed to.

As used herein, the term “composite including a microwave regulating material” refers to a melded material in which at least one substance is combined with a microwave regulating material to produce microwave reflective properties not present in the substance alone. In other words, containers in accordance with the present disclosure may comprise composites, wherein the material of the packaging container is formed with the microwave regulating material such that the microwave regulating material is part of the container, thereby eliminating the secondary production step of applying a microwave regulating layer, such as, for example, a microwave shielding layer, to the container. In various embodiments, for example, wherein the container comprises a paperboard material, the composite may comprise the microwave regulating material laminated to the paperboard material. In various additional embodiments, wherein the container comprises a plastic material, the composite may comprise the microwave regulating material molded with, or laminated to, the plastic material. Those of ordinary skill in the art would understand, however, that containers in accordance with the present disclosure may be made of various materials, and composites thereof may comprise various materials and may be formed using various methods and/or techniques known in the art.

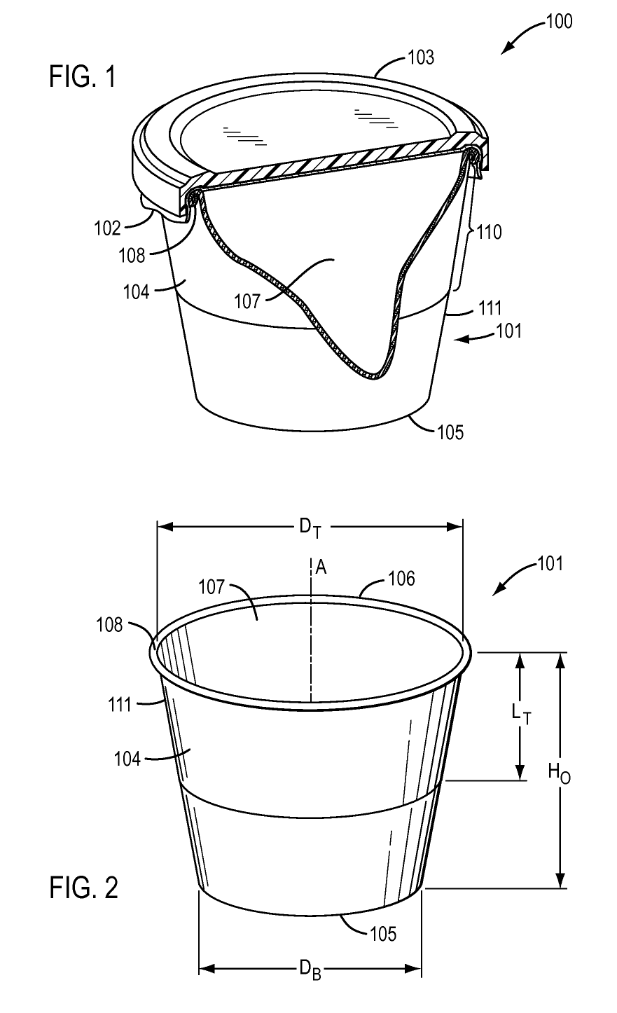

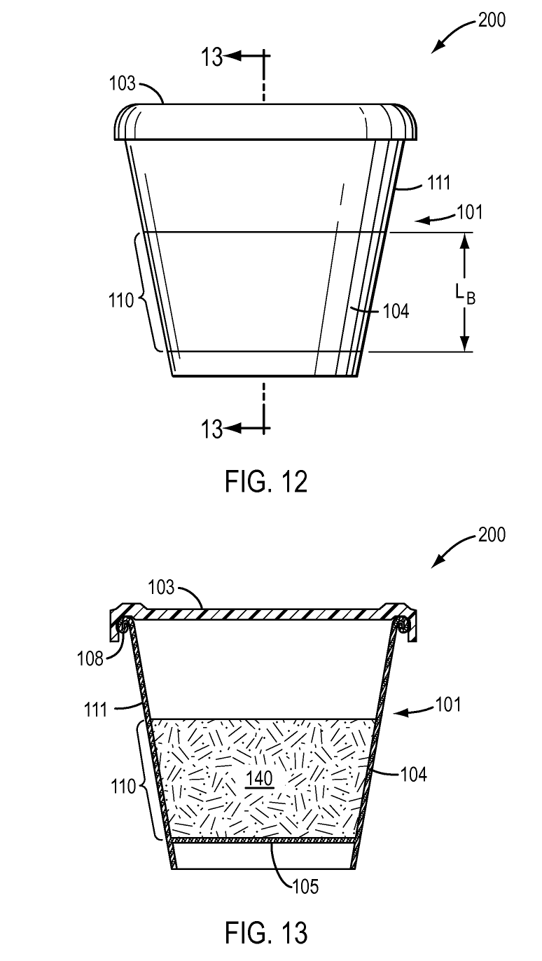

FIGS. 1-8, 12, and 13 illustrate exemplary microwavable food packages in accordance with various exemplary embodiments of the present disclosure. A microwavable food package includes a container 101 and a cover, such as, for example, a sheet 102 as illustrated in the embodiment of microwaveable food package 100 (FIGS. 1-8), or a lid 103 as illustrated in the embodiment of microwavable food package 200 (FIGS. 12 and 13). The container 101 includes at least one sidewall 104, a first closed end 105, and a second open end 106 opposite the first closed end 105. Thus, as illustrated perhaps best in FIG. 1, the sidewall 104 and the closed end 105 together define an interior volume 107 that is sized and configured to hold foodstuff for microwaving. The cover may be removably secured to the container 101 to cover the open end 106 and seal the interior volume 107. In various embodiments, for example, the container 101 includes a lip 108 that surrounds the open end 106, and the cover may be secured to the container 101 at the lip 108, as illustrated in FIG. 1.

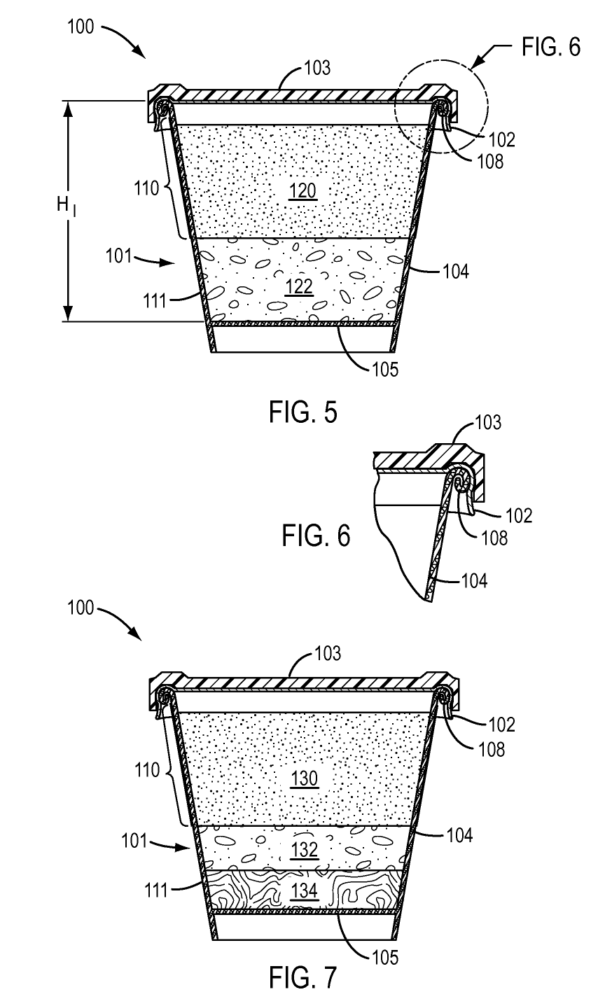

In various exemplary embodiments of the present disclosure, the container 101 may comprise a cup 111 as illustrated, for example, in the embodiments of FIGS. 1-8, 12 and 13. In various embodiments, for example, as shown in FIG. 2, the cup 111 may have a circular cross-section and the sidewall 104 of the cup may taper at an angle θ, such that the cup has a slight frustoconical shape, wherein a diameter D_{T} of the open end 106 of the cup is larger than a diameter D_{B} of the closed end 105 of the cup. Various exemplary embodiments of the present disclosure contemplate, for example, cup 111 having an outside height Hₒ (FIG. 2) ranging from about 46 mm to about 58 mm, an inside height H_{I} (FIG. 5) ranging from about 39 mm to about 50 mm, a diameter D_{T} ranging from about 64 mm to about 74 mm, and a diameter D_{B} ranging from about 54 mm to about 56 mm. Various additional exemplary embodiments contemplate cups 111 having an interior volume 107 ranging from about 50 ml to about 250 ml. Those of ordinary skill in the art would understand, however, that the cup illustrated in FIGS. 1-8, 12 and 13 is exemplary only, and that containers in accordance with the present disclosure may have various configurations, shapes, dimensions, and/or volumes based on the type, configuration, quantity, and/or dimensions of the foodstuffs intended to be packaged therein. In various additional embodiments, for example, the container 101 may comprise a carton, box and/or other structure suitable for packaging microwavable foodstuffs.

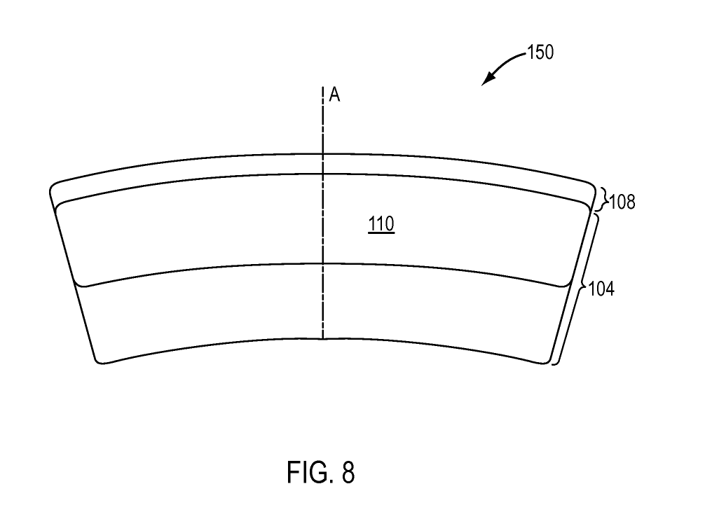

Those of ordinary skill in the art would further understand that containers in accordance with the present disclosure may be made of various materials that are suitable for both food packaging applications and exposure to microwave radiation, and that such containers may be made and/or formed using various methods and/or techniques. In various exemplary embodiments of the present disclosure, the container 101 may comprise a paperboard material, such as, for example, a paperboard material with a hydrophobic coating, such as, for example, a low-density polyethylene (LDPE) coating. As shown in FIG. 8, for example, in various embodiments, wherein the container 101 is a paperboard cup, the container 101 may be formed from a planar blank 150, which is rolled about an axis A to form the sidewall 104 of the cup and combined with bottom stock (not shown) to form a structure suitable for packaging foodstuffs therein, as would be understood by those of ordinary skill in the art. In various additional exemplary embodiments (not shown), the container 101 may comprise a plastic material, such as, for example, a high density polyethylene (HDPE), that is extruded and/or molded to form the container structure.

To control the amount of incident microwave radiation being transmitted through the sidewall 104 of the container 101 into the interior volume 107, the sidewall 104 of the container 101 comprises a composite 110 including a microwave regulating material, such as, for example, a microwave shielding material. As above, the composite 110 may include various microwave regulating materials, including, but not limited to, electrically conductive materials, such as, for example, metallic foils or patterned foils made of aluminum, copper, tin, brass, steel, or various metal or metal alloys which are effective to reflect (or partially reflect) microwaves. The composite 110 may also be formed using various methods and/or techniques known to those skilled in the art. In various embodiments, for example, wherein the container 101 is made of a paperboard material, the composite may comprise the microwave regulating material laminated to the paperboard material of the container 101. As shown in FIG. 8, the composite laminate 110 may be formed as part of the planar blank 150, such as, for example, as a patterned foil laminated to the paperboard material of the blank 150. In various additional embodiments, wherein the container 101 is made of a plastic material, the composite 110 may comprise the microwave regulating material molded or extruded with the plastic material of the container 101. In various additional embodiments, the composite 110 may comprise the microwave regulating material laminated to a plastic material forming container 101.

As illustrated in FIGS. 1-4 and 12, in various exemplary embodiments of the present disclosure, wherein the container 101 is a cup 111, the composite 110 may be located along the sidewall 104 of the cup 111 to completely radially surround a portion of the interior volume 107. In various embodiments, as shown in FIGS. 1-8, for example, wherein it is desirable to control the amount of microwave energy transmitted through the top portion of the container 101 proximate the opening 106, the composite 110 may surround a portion of the interior volume 107 from the open end 106 to a location along a longitudinal axis A of the container 101. In other words, in various embodiments, the composite 110 may extend a length L_{T} of the container 101, as shown FIG. 2. In various additional embodiments, wherein the container 101 comprises a lip 108 surrounding the open end 106, the composite 110 may extend a length L_{T} of the container 101 from just below the lip 108. In various embodiments, for example, the composite 110 may extend a length L_{T} ranging from about 32 mm to about 50 mm from just below the lip 108.

In various additional embodiments, as shown in FIGS. 12 and 13, wherein it is desirable to control the amount of microwave energy transmitted through a bottom portion of the container 101, the composite 110 may surround a portion of the interior volume 107 from the closed end 105 to a location along the longitudinal axis A of the container 101. In other words, in various embodiments, the composite 110 may extend a length L_{B} of the container 101, as shown FIG. 12.

As would be understood by those of ordinary skill in the art, however, the composite 110 may be positioned in a variety of locations along the sidewall 104, on either an inside surface of the side wall 104 (not shown) or an outside surface of the sidewall 104, and may extend various lengths along the longitudinal axis A of the container 101 (including the full length of the sidewall 104), depending on the shape and/or dimensions of the container 101 and the types, configurations, and/or thicknesses of the foodstuffs held within the container 101. Furthermore, the composite 110 may have various shapes and/or configurations, and may form various patterns and/or designs along the sidewall 104, in a circumferential and/or longitudinal direction, depending on the types and configurations of the foodstuffs held within the container 101. In various embodiments, for example, as illustrated in the embodiments of FIGS. 1-8, 12 and 13, the composite may completely radially surround a portion of the sidewall 104. And, in various additional embodiments, the composite 110 may only partially radially surround the sidewall 104. Thus, it is within the ability of one ordinarily skilled in the art to determine the desired location, dimensions, shape, configuration, and/or design of the composite 110 based upon a given microwavable food product and packaging application.

To further control the amount of incident microwave radiation being transmitted into the interior volume 107 of the container 101 (i.e., through the open end 106 or the closed end 105), either the cover, such as, for example, sheet 102 (FIGS. 1 and 3-7) or the closed end 105 (FIGS. 12 and 13) may also comprise a microwave regulating material, such as, for example, a microwave shielding material. In various embodiments of the present disclosure, for example, the cover includes a microwave regulating material disposed to regulate incident microwave radiation being transmitted through the open end 106 into the interior volume 107 when the cover is, for example, secured to the container 101. The microwave regulating material of the cover may include various microwave regulating materials, including, but not limited to, electrically conductive materials, such as, for example, metallic foils or patterned foils made of aluminum, copper, tin, brass, steel, or various metal or metal alloys which are effective to reflect (or partially reflect) microwaves. As above, the cover may be configured to be removably secured to the container 101 to cover the open end 106 of the container 101.

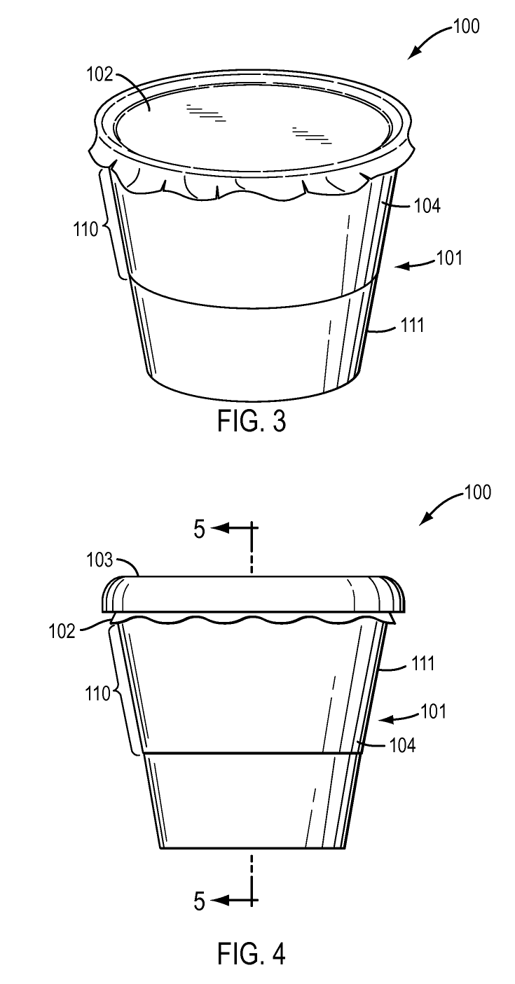

As illustrated in the embodiment of FIGS. 1-8, in various embodiments of the present disclosure, the cover may comprise a sheet 102, such as, for example, an aluminum foil sheet, membrane, or lamination that can be induction and/or heat sealed to the open end 106 of the container 101. In various embodiments, the sheet 102 may be sealed to the lip 108 of the container 101, as best shown perhaps in FIG. 3. In such a configuration, the sheet 102 may provide both a freshness seal and a tamper-evident seal for the foodstuffs held within the container 101.

In various embodiments of the present disclosure, for example, the sheet 102 may comprise a circular, foil lamination including, but not limited to, various layers of oriented polypropylene (OPP), print, low-density polyethylene (LDPE), aluminum foil, polyethylene terepthalate (PET), and/or a polyethylene (PE) sealant film, arranged in various configurations. Those of ordinary skill in the art would understand, however, that sheets in accordance with the present disclosure may be made of various materials, including various laminate layers and configurations, and may have various shapes and/or dimensions (e.g., thicknesses and diameters) depending on the container being covered. In various embodiments, for example, the sheet 102 may have a thickness ranging from about 0.0072 mm to about 0.0089 mm, and a diameter ranging from about 6.98 cm to about 8.26 cm, to adequately cover and/or seal a container 101 having the shape and dimensions disclosed above.

In various additional embodiments, wherein the sheet 102 is used, for example, in conjunction with a container 101 that is made of a paperboard material, the sheet 102 may extend along the sidewall 104, such that the sheet 102 extends around and below the lip 108 of the container 101, as best shown perhaps in the enlarged view of FIG. 6. Such a configuration, wherein the cover extends around and below the lip 108 of the container 101, has been found to prevent scorching and burning of containers made of dielectric materials, such as, paperboard. While not wishing to be bound by a particular theory, it is believed that when microwave regulating materials, such as, for example, microwave shielding materials, are used in both the sidewall 104 of the container 101 and the cover 102, microwave energy is concentrated between the shielding materials, and will radiate out between the materials if there are any gaps in effective electromagnetic shielding. Thus, when dielectric materials (with low attenuation coefficients), such as, for example, paperboard, are used to form the container 101, the container 101 may interact with this concentrated energy, causing scorching and burning of the container 101, for example, at the lip 108 of the container 101 (where gaps in the effective electromagnetic shielding are generally formed between the shielding materials of the container 101 and the cover 102). Such energy points can be masked, for example, by overlapping the shielding materials of the container 101 and the cover 102 (i.e., by extending the cover 102 along the sidewall 104 to overlap with the composite 110). It is to be understood, however, that overlapping shielding materials need not contact one another to result in an effective electromagnetic shield. Examples of overlapping shielding materials that create an effective electromagnetic shield are shown in FIGS. 5, 6, and 7. In some embodiments, shielding materials can be positioned such that an effective electromagnetic shield is created, but arcing between edges of the shielding materials is reduced or avoided.

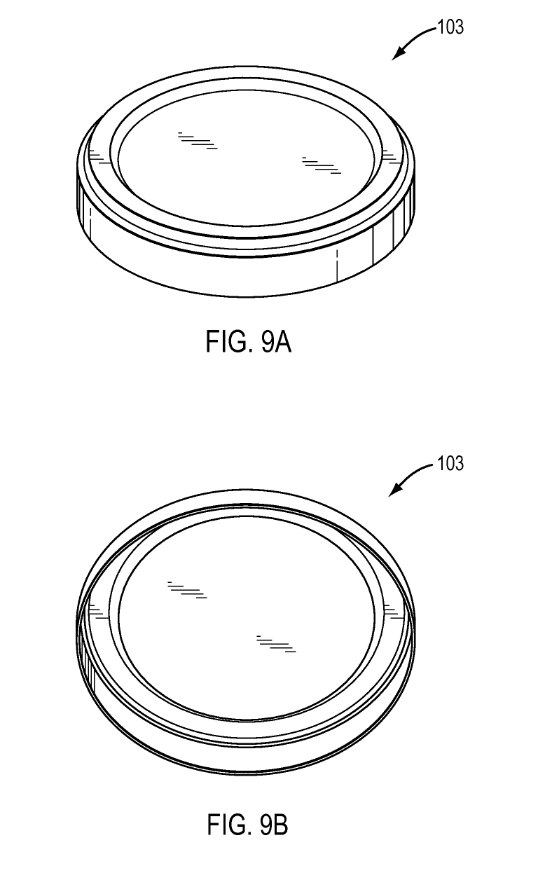

As best shown perhaps in FIGS. 1, 4, and 6, in various embodiments, wherein the cover comprises a sheet 102, the package 100 may further include a removable lid 103 that is configured to snap-fit or friction-fit to the lip 108 of the container 101 over the sheet 102. As shown in FIGS. 9A and 9B, for example, in various embodiments, the lid 103 may comprise a circular, molded plastic material, such as, for example, a high-density polyethylene (HDPE), that is molded to snap-fit or friction-fit to the lip 108 as would be understood by those of ordinary skill in the art. Lids in accordance with the present disclosure may, however, be made of various materials, including various plastic, paperboard, and/or foil materials, may be configured to be secured to the container via various methods, and may have various shapes and/or dimensions (e.g., diameters), depending on the container being covered. In various embodiments, for example, the lid 103 may have a diameter ranging from about 64 mm to about 74 mm to adequately cover a container 101 and a sheet 102 having the shape and dimensions disclosed above.

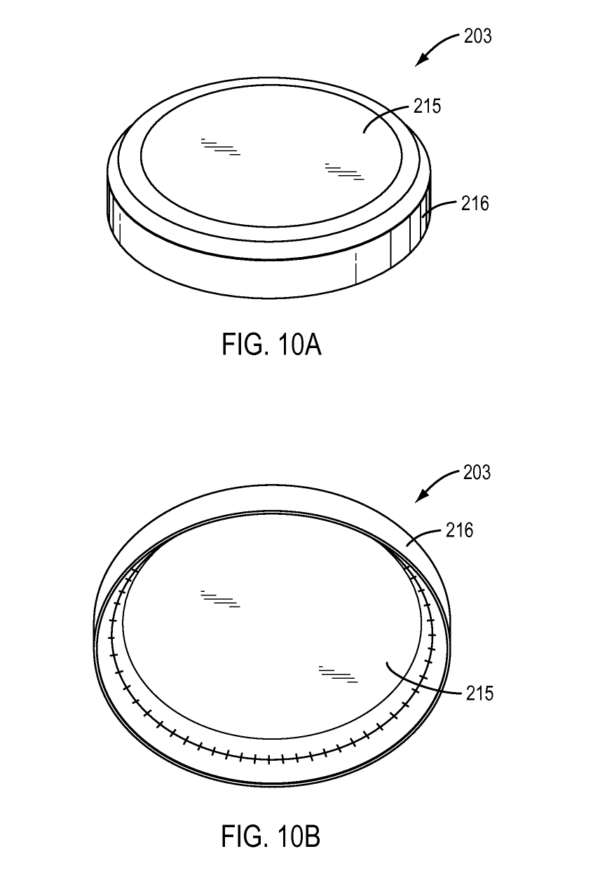

In various additional embodiments of the present disclosure, the cover may comprise a lid without an underlying sheet cover, wherein the lid itself includes the microwave regulating material. In various embodiments, for example, the cover may comprise a lid that is configured to snap-fit or friction-fit directly to the lip 108 of the container 101 in the manner described above (e.g., with no intermediate sheet 102). As shown in FIGS. 10A and 10B, in various embodiments, a lid 203 may have a laminated construction in which the lid 203 includes the microwave regulating material laminated to a paperboard material, such as, for example, a foil laminated to the paperboard material. In various embodiments, when it is desired, for example, to have the microwave regulating material extend along the sidewall 104 and overlap with the composite 110, the entire lid 203 may be made of the foil laminate material or a thick foil material. And, in various additional embodiments, as illustrated in FIGS. 10A and 10B, only a portion of the lid 203 may be made of the foil laminate, such as, for example, a circular, body portion 215 of the lid 203, while a circular rim 216 of the lid 203 is made of a plastic material. In both exemplary configurations, the microwave regulating material may be located on either the top and/or bottom surfaces of the lid 203.

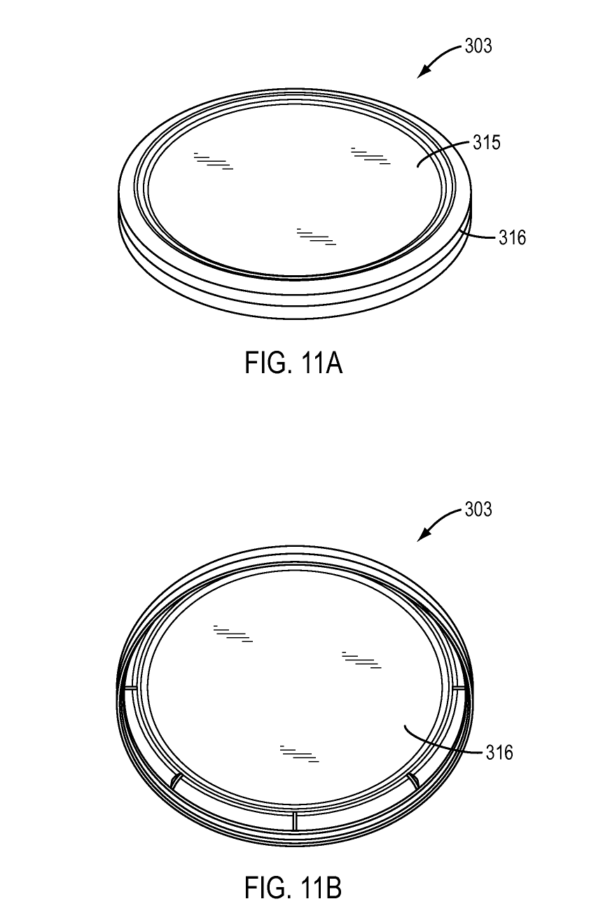

As shown in FIGS. 11A and 11B, in various additional embodiments, a lid 303 may have a molded plastic construction in which the lid 303 includes the microwave regulating material, such as, for example, a foil molded with plastic (e.g., using a mold labeling technology), or a foil laminated plastic, as would be understood by those of ordinary skill in the art. As above, in various embodiments, when it is desired, for example, to have the microwave regulating material extend along the sidewall 104 and overlap with the composite 110, an entire surface (i.e., top and/or bottom) of the lid 303 may include the foil mold. And, in various additional embodiments, as illustrated in FIGS. 11A and 11B, only a portion of the lid 303 may include the foil mold, such as, for example, a circular, surface portion 315 of the lid 303, while the remaining portions 316 of the lid 303 are made of a plastic material. As above, in both exemplary configurations, the microwave regulating material may be located on either the top and/or bottom surfaces of the lid 303.

Those of ordinary skill in the art would understand that the lids 103, 203, and 303 illustrated and described above with reference to FIGS. 9A, 9B, 10A, 10B, 11A, and 11B are exemplary only, and are intended to demonstrate three types of lids with which the principles of the present disclosure may be used. Accordingly, it is contemplated that microwave regulating materials may be applied to any type, size, shape, and/or configuration of lid as understood by those of ordinary skill in the art, including, but not limited to, snap-fit, friction-fit, and screw-top lids. Moreover, microwave regulating materials may be applied to lids in various shapes and/or configurations, and may form various patterns and/or designs on the lids, depending on the types and configurations of the foodstuffs held within the container 101. In various embodiments, for example, as illustrated in the embodiments of FIGS. 10A, 10B, 11A, and 11B, the microwave regulating material may completely cover a top portion of the lid 203, 303. And, in various additional embodiments, the microwave regulating material may only partially cover the top portion of the lid 203, 303. Thus, it is within the ability of one ordinarily skilled in the art to determine the desired dimensions, shape, configuration, and/or design of the microwave regulating material applied to the lid based upon a given microwavable food product and packaging application.

In various additional embodiments of the present disclosure, as illustrated in the embodiments of FIGS. 12 and 13, the cover (e.g., lid 103) does not include a microwave regulating material, and the closed end 105 includes a microwave regulating material disposed to regulate incident microwave radiation being transmitted through the closed end 105 into the interior volume 107 of the container 101. As above, the microwave regulating material of the closed end 105 may include various microwave regulating materials, including, but not limited to, electrically conductive materials, such as, for example, metallic foils or patterned foils made of aluminum, copper, tin, brass, steel, or various metal or metal alloys which are effective to reflect (or partially reflect) microwaves. In various embodiments, for example, wherein the container comprises a paperboard material, the closed end may comprise the microwave regulating material laminated to the paperboard material. In various additional embodiments, wherein the container comprises a plastic material, the closed end may comprise a microwave regulating material molded with the plastic material or laminated to the plastic material. Moreover, as above, microwave regulating materials may be applied to the closed end 105 of the container 101 in various shapes and/or configurations, and may form various patterns and/or designs on the closed end 105, depending on the types and configurations of the foodstuffs held within the container 101. Thus, it is within the ability of one ordinarily skilled in the art to determine the desired dimensions, shape, configuration, and/or design of the microwave regulating material applied to the closed end based upon a given microwavable food product and packaging application.

Those of ordinary skill in the art would understand that the microwavable food packages 100 and 200 respectively shown and described above with reference to FIGS. 1-8 and 12-13 are exemplary only, and are intended to demonstrate two types of microwavable food packages in accordance with the present disclosure. Microwavable food packages in accordance with the present disclosure may have various sizes, shapes, and/or configurations, including, for example, various sizes, shapes, and/or configurations of containers, lips (e.g., flattened lip), covers, and/or lids.

As above, microwavable food packages in accordance with the present disclosure may provide differential heating between two or more foodstuffs held within the container, or provide uniform heating of one or more foodstuffs held within the container, by effectively regulating the amount of incident microwave radiation being transmitted to at least a first layer of foodstuff positioned radially adjacent to the composite. In accordance with various embodiments, for example, microwavable food packages may effectively shield at least a first layer of foodstuff positioned radially adjacent to the composite. As illustrated in the cross-sectional view of FIG. 5, with reference to the exemplary embodiment of FIGS. 1-8 described above, the microwavable food package 100 may provide differential heating between two or more differing layers of foodstuffs 120 and 122 packaged within the interior volume 107 of the container 101 by shielding the first layer of foodstuff 120 from incident microwave radiation via the sheet 102 and the composite 110.

As shown in FIG. 5, for example, in various embodiments of the present disclosure, the first layer of foodstuff 120 is positioned on top of the second layer of foodstuff 122, such that the second layer 122 is disposed closer to the closed end 105 of the container 101 than the first layer 120. In other words, the first layer of foodstuff 120 is oriented within a top portion of the interior volume 107 and is radially-adjacent to and surrounded by the composite 110, while the second layer of foodstuff 122 is oriented within a bottom portion of the interior volume 107 and is not surrounded by the composite 110 or is partially surrounded by composite 110. In such a configuration, the first layer of foodstuff 120 may be substantially shielded from incident microwave radiation via at least the sheet 102 and the composite 110. Thus, when the package 100 is microwaved, the first layer of foodstuff 120 is substantially shielded from the microwaves, while the second layer of foodstuff 122 is relatively unprotected and therefore exposed to and heated by the microwaves.

In various exemplary embodiments, the first layer of foodstuff 120 may therefore include a foodstuff configured to be consumed chilled or frozen, for example, being served at a temperature ranging from about −18° C. to about 10° C., and the second layer of foodstuff 122 may include a foodstuff configured to be consumed warm or hot, for example, being served at a temperature ranging from about 27° C. to about 71° C. In various embodiments, for example, the first layer of foodstuff 120 may be chosen from an ice cream, ice milk, frozen yogurt, custard, pudding, sorbet, malt, yogurt, fruit, fillings, whipped cream, frosting, dessert toppings, cold confections, or blends thereof. And, the second layer of foodstuff 122 may be chosen from a brownie, cake, cookie, biscuit, bread, pie, fudge, chocolate, caramel, butterscotch, fruit, syrup, sauces, or blends thereof.

As illustrated in the cross-sectional view of FIG. 7, in various additional exemplary embodiments, the microwavable food package 100 may provide differential heating between three differing layers of foodstuffs 130, 132, and 134 packaged within the interior volume 107 of the container 101. As shown in FIG. 7, in such a configuration, the first layer of foodstuff 130 is positioned on top of the second layer of foodstuff 132, and the second layer of foodstuff 132 is positioned on top of a third layer of foodstuff 134, such that the third layer 134 is directly adjacent to the closed end 105 of the container 101. In other words, the first layer of foodstuff 130 is oriented within a top portion of the interior volume 107 and is radially-adjacent to and surrounded by the composite 110, while the second and third layers of foodstuff 132 and 134 are oriented within a bottom portion of the interior volume 107 and are not surrounded by the composite 110 or are partially surrounded by composite 110. Thus, as above, when the package 100 is microwaved, the first layer of foodstuff 130 is substantially shielded from the microwaves, while the second and third layers of foodstuff 132 and 134 are relatively unprotected and therefore exposed to and heated by the microwaves. To expose the second layer of foodstuff 132 to varying levels of heat, in various additional embodiments, although not shown, both the first and second layers of foodstuff 130 and 132 (or the first layer 130 and a portion of the second layer 132) may be oriented radially-adjacent to and surrounded, or partially surrounded by, by the composite 110.

In various embodiments, for example, the first layer of foodstuff 130 may be chosen from an ice cream, ice milk, frozen yogurt, custard, pudding, sorbet, malt, yogurt, fruit, fillings, whipped cream, frosting, dessert toppings, cold confections, or blends thereof. The second layer of foodstuff 132 may be chosen from a brownie, cake, cookie, biscuit, bread, pie, or blends thereof. And, the third layer of foodstuff 134 may be chosen from fudge, chocolate, caramel, butterscotch, fruit, syrup, sauces, or blends thereof.

Various exemplary embodiments of the preset disclosure contemplate microwavable food products that not only utilize food packages that provide differential heating between two or more foodstuffs held within the package as described above, but that may also provide differential heating between the foodstuffs by exploiting the physical properties of the foodstuffs themselves to further provide an edible, foodstuff shielding layer. This foodstuff shielding layer, in combination with the composite 110 and the sheet 102 (which respectively comprise microwave regulating materials, such as, for example, microwave shielding materials, as described above) may further prevent detrimental heating, for example, of the first foodstuff layer 120, 130 packaged within the container 101. As disclosed, for example, in U.S. Pat. No. 4,926,020, issued on May 15, 1990; U.S. Pat. No. 4,988,841, issued on Jan. 29, 1991; and U.S. Pat. No. 5,008,507, issued on Apr. 16, 1991, the entire contents of each of which are incorporated by reference herein, by controlling the geometry (e.g., thickness) and dielectric properties of the foodstuff layers held within the package, it is possible to control the reflectance, absorbance, shielding ability, and heating rate of the layers, thereby permitting the design of various foodstuff layer arrangements (including various foodstuff shielding layers).

Thus, with reference to the exemplary embodiments described above, the food stuff layers 120, 122, 130, 132, and 134 each respectively have a thickness and dielectric properties, which may be adjusted to provide differential heating between the layers. In various embodiments, for example, in which there are two layers of foodstuff 120 and 122 (FIG. 5), the thickness and dielectric properties of the first layer 120 may be selected relative to the thickness and dielectric properties of the second layer 122 so that the second layer 122 effectively shields the first layer 120 from microwave radiation. Thus, the composite 110, the sheet 102, and the second layer of foodstuff 122 may cooperate with one another to substantially completely surround the first layer of foodstuff 120 to keep the first layer of foodstuff 120 within a preselected temperature range during exposure to microwave radiation.

In the same manner, in various embodiments, in which there are three layers of foodstuffs 130, 132, and 134 (FIG. 7), the thickness and dielectric properties of the first layer 130 may be selected relative to the thickness and dielectric properties of the second and third layers 132 and 134 so that the first layer 130 is effectively shielded from microwave radiation by the second and third layers 132 and 134. By way of non-limiting example, in various embodiments of the present disclosure, the first layer of foodstuff 130 is an ice cream, such as, for example, an ice cream product produced by Häagen-Dazs® having a thickness ranging from about 20% to about 70% of the container height H_{I}; the second layer of foodstuff 132 is a brownie having a thickness ranging from about 10% to about 50% of the container height H_{I}, and the third layer of foodstuff 134 is a fudge sauce having a thickness ranging from about 5% to about 25% of the container height H_{I}.

To provide uniform heating, for example, of a single foodstuff held within the container, in accordance with various additional embodiments, microwavable food packages may also partially attenuate and/or modify microwave energy as it passes through the composite 110 to a layer of foodstuff positioned radially adjacent to the composite 110. As illustrated in the cross-sectional view of FIG. 13, with reference to the exemplary embodiment of FIGS. 12 and 13 described above, the microwavable food package 200 may provide uniform heating of a foodstuff 140 packaged within the interior volume 107 of the container 101 by moderating the microwave radiation transmitted through the composite 110.

As shown in FIG. 13, for example, in various embodiments of the present disclosure, the foodstuff 140 is oriented within a bottom portion of the interior volume 107 of the container 101 and is radially-adjacent to and surrounded by the composite 110. In such a configuration, the microwave radiation being transmitted to the foodstuff 140 (through the composite 110 and the closed end 105) may, for example, be moderated to more evenly thaw, heat, and/or bake the foodstuff 140. In various embodiments, for example, the foodstuff 140 may be chosen from a soup, batter, or pasta.

Those of ordinary skill in the art would understand that the foodstuffs, foodstuff layer arrangements, and configurations described above are exemplary only, and that any number, type, thickness, and/or configuration of foodstuff and foodstuff layers can be packaged within the microwavable food packages of the present disclosure without departing from the scope of the present disclosure and claims. Furthermore, based on the teachings of the present disclosure and the materials incorporated by reference herein, it is within the ability of one skilled in the art to preselect the arrangement, thicknesses, and dielectric properties of the foodstuff layers packaged within the microwavable food package to achieve a desired heating profile, and the present disclosure is not intended to be limited to the exemplary embodiments shown and described herein.

An exemplary method for preparing a food product in accordance with an exemplary embodiment of the present disclosure is set forth in the following description with reference to the microwave food package 100 of the embodiment of FIGS. 1-8. A container 101 holding at least a first foodstuff 120, 130 and a second foodstuff 122, 132 may be applied with microwave energy, such as, for example, by being heated in a microwave oven. As above, in various exemplary embodiments, the first and second foodstuffs 120, 130 and 122, 132 may be held in axially layered relation to each other within an interior volume 107 of the container 101 as illustrated in FIGS. 5 and 7.

While the product is microwaved (i.e., exposed to microwave radiation), the microwave energy being transmitted through a sidewall 104 of the container 101 to the first foodstuff 120, 130 may be regulated, such that the foodstuff 120, 130 remains within a predetermined temperature range, while the second foodstuff 122, 132 is heated with the microwave energy. In various embodiments, for example, the first foodstuff 120, 130 may be shielded from the microwave energy that is transmitted through a sidewall 104 of the container 101 via a composite 110 that includes a microwave regulating material, such as, for example, a microwave shielding material, and may be further shielded from the microwave energy that would otherwise be transmitted through an open end 106 of the container 101 via a cover, such as, for example, a sheet 102 that includes a microwave regulating material.

As above, to prevent scorching and burning of the container 101 during exposure to microwave energy, for example, at a lip 108 that surrounds the open end 106 of the container 101, in various additional embodiments, the first foodstuff 120, 130 may be shielded via a sheet 102 that extends around and below the lip 108 to overlap with the composite 110.

As illustrated in FIG. 7, in various further embodiments, a third foodstuff 134 may be held in axially layered relation to the first and second foodstuffs 130, 132 within the interior volume 107 of the container 101. And, while the product is microwaved (i.e., exposed to microwave radiation), the first foodstuff 130 may be shielded from the microwave energy, while the second and third foodstuffs 132 and 134 are heated with the microwave energy.

Although the detailed description and exemplary illustrated embodiments were described with reference to microwavable food products, it will be appreciated by those ordinarily skilled in the art having the benefit of this disclosure that the present disclosure may also provide microwavable packaging embodiments, products, and methods for preparing such products for various additional applications. In particular, the embodiments described could be used for a variety of purposes in which it is desirable to provide differential heating between two or more substances positioned adjacent one another in a multi-component product, and/or in which it is desirable to provide uniform heating, for example, of a single-component product. Further modifications and alternative embodiments to accommodate such applications would be apparent to those skilled in the art in view of this description.

The microwavable food package embodiments and products may also include additional components that were omitted from the drawings for clarity of illustration. Accordingly, this description is to be construed as illustrative only and is for the purpose of teaching those skilled in the art the general manner of carrying out the present disclosure.

It is to be understood that the various embodiments shown and described herein are to be taken as exemplary. Elements and materials, and arrangements of those elements and materials, may be substituted for those illustrated and described herein, parts may be reversed, and certain features of the present disclosure may be utilized independently, all as would be apparent to one skilled in the art after having the benefit of the description herein. Changes may be made in the elements described herein without departing from the spirit and scope of the present disclosure and following claims, including their equivalents.

It is to be understood that the particular examples and embodiments set forth herein are non-limiting, and modifications to structure, dimensions, materials, and methodologies may be made without departing from the scope of the present disclosure.

It is to be further understood that this description's terminology is not intended to limit the invention. For example, spatially relative terms, such as “front”, “back,” “top”, “bottom”, “side,” and the like, may be used to describe one element's or feature's relationship to another element or feature as intended to connote the orientation of the container for display and use and as illustrated in the figures. These spatially relative terms are intended to encompass different positions (i.e., locations) and orientations (i.e., rotational placements) of a container in use in addition to the position and orientation shown in the figures. For example, if a container in the figures is turned over, elements described as “top” or “bottom” would then be reversed. A container may also be otherwise oriented (rotated 90 degrees or at other orientations) and the spatially relative descriptors used herein interpreted accordingly.

For the purposes of this specification and appended claims, unless otherwise indicated, all numbers expressing quantities, percentages or proportions, and other numerical values used in the specification and claims, are to be understood as being modified in all instances by the term “about” if they are not already. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It should be understood that while the present disclosure have been described in detail with respect to various exemplary embodiments thereof, it should not be considered limited to such, as numerous modifications are possible without departing from the broad scope of the appended claims, including the equivalents they encompass.

We claim:

1. A microwavable food package comprising:
a container comprising at least one sidewall, a first closed end and a second open end opposite the first closed end, the at least one sidewall and the first closed end together defining an interior volume configured to hold foodstuff; and
a cover configured to cover the open end,
wherein the at least one sidewall comprises a composite including a microwave regulating material to regulate incident microwave radiation being transmitted through the at least one sidewall into the interior volume, and
wherein the cover or the closed end comprises a microwave regulating material to regulate incident microwave radiation being transmitted through an end of the container into the interior volume.

2. The package of claim 1, wherein the composite comprises the microwave regulating material laminated to a paperboard material.

3. The package of claim 1, wherein the composite comprises the microwave regulating material and a plastic material.

4. The package of claim 1, wherein the microwave regulating material of the cover, closed end, and the composite is an electrically conductive material.

5. The package of claim 4, wherein the composite comprises a patterned foil.

6. The package of claim 1, wherein the cover is configured to be removably secured to the container to cover the open end.

7. The package of claim 6, wherein the cover is a lid.

8. The package of claim 7, wherein the lid is of a molded or laminated construction.

9. The package of claim 1, wherein the composite surrounds a portion of the interior volume from the open end to a location along a longitudinal axis of the container.

10. The package of claim 1, wherein the composite surrounds a portion of the interior volume from the closed end to a location along a longitudinal axis of the container.

11. The package of claim 1, wherein the container further comprises a lip surrounding the open end.

12. The package of claim 11, wherein the cover comprises a foil sheet covering the lip in a secured position to the container.

13. The package of claim 12, wherein the foil sheet extends along the at least one sidewall.

14. The package of claim 12, further comprising a removable lid configured to snap-fit or friction-fit to the lip of the container over the foil sheet.

15. A microwavable product comprising:
a cup comprising a sidewall, a closed end, and an open end opposite the closed end, wherein the sidewall and the closed end together define an interior volume, and wherein the cup further comprises a lip surrounding the open end;
a first layer of foodstuff disposed within the interior volume, the first layer of foodstuff having a thickness and dielectric properties;
a second layer of foodstuff disposed within the interior volume below the first layer and closer to the closed end than the first layer, the second layer of foodstuff having a thickness and dielectric properties, wherein the foodstuffs of the first and second layers differ from each other; and
a cover removably secured to the cup at the open end, the cover comprising a microwave regulating material disposed to regulate incident microwave radiation being transmitted through the open end into the interior volume of the cup,
wherein the sidewall comprises a composite including a microwave regulating material disposed to surround at least the first layer of foodstuff to regulate incident microwave radiation from being transmitted through the sidewall into the interior volume at a location of the first layer.

16. The product of claim 15, wherein the composite comprises the microwave regulating material laminated to a paperboard material.

17. The product of claim 15, wherein the composite comprises the microwave regulating material and a plastic material.

18. The product of claim 15, wherein the cover comprises a foil sheet covering the lip in a secured position to the cup, and wherein the foil sheet extends along the sidewall.

19. The product of claim 15, wherein the cover is a lid of a molded or laminated construction.

20. The product of claim 15, wherein the first layer of foodstuff comprises a foodstuff configured to be consumed chilled or frozen, and wherein the second layer of foodstuff comprises a foodstuff that is configured to be consumed warm or hot.

21. The product of claim 20, wherein:
the first layer of foodstuff is chosen from an ice cream, ice milk, frozen yogurt, custard, pudding, sorbet, malt, yogurt, fruit, fillings, whipped cream, frosting, dessert toppings, cold confections, or blends thereof; and
the second layer of foodstuff is chosen from a brownie, cake, cookie, biscuit, bread, pie, fudge, chocolate, caramel, butterscotch, fruit, syrup, sauces, or blends thereof.

22. The product of claim 15, further comprising a third layer of foodstuff disposed within the interior volume below the second layer and closer to the closed end than the second layer, the third layer of foodstuff having a thickness and dielectric properties.

23. The product of claim 22, wherein:
the first layer of foodstuff is chosen from an ice cream, ice milk, frozen yogurt, custard, pudding, sorbet, malt, yogurt, fruit, fillings, whipped cream, frosting, dessert toppings, cold confections, or blends thereof;
the second layer of foodstuff is chosen from a brownie, cake, cookie, biscuit, bread, pie, or blends thereof; and
the third layer of foodstuff is chosen from fudge, chocolate, caramel, butterscotch, fruit, syrup, sauces, or blends thereof.

24. The product of claim 15, wherein the thickness and dielectric properties of the first layer of foodstuff are selected relative to the thickness and dielectric properties of the second layer of foodstuff so that the first layer of foodstuff maintains a preselected temperature range during exposure to microwave radiation.

25. A method for preparing a food product, the method comprising:
applying microwave energy to a container holding at least a first foodstuff and a second foodstuff, the first and second foodstuffs being held in axially layered relation to each other within an interior volume of the container;
regulating the microwave energy being transmitted through a first end of the container to the first foodstuff;
regulating the microwave energy being transmitted through a sidewall of the container to the first foodstuff via a composite including a microwave regulating material; and
heating the second foodstuff with the microwave energy transmitted through the sidewall and a second end of the container.

26. The method of claim 25, wherein regulating the microwave energy being transmitted through the first end of the container comprises regulating the microwave energy via a cover around and below a lip of the container surrounding an open end of the container.

27. The method of claim 25, further comprising heating a third foodstuff with the microwave energy, wherein the third foodstuff is disposed in an axially layered relation to the first and second foodstuffs within the interior volume of the container.

28. The method of claim 27, wherein regulating the first foodstuff is chosen from an ice cream, ice milk, frozen yogurt, custard, pudding, sorbet, malt, yogurt, fruit, fillings, whipped cream, frosting, dessert toppings, cold confections, or blends thereof;
wherein the second foodstuff is chosen from a brownie, cake, cookie, biscuit, bread, pie, or blends thereof; and
wherein the third foodstuff is chosen from fudge, chocolate, caramel, butterscotch, fruit, syrup, sauces, or blends thereof.
